(19) United States
(12) Patent Application Publication
(10) Pub. No.: US 2009/0086595 A1
(43) Pub. Date: Apr. 2, 2009

(54) OPTICAL INFORMATION RECORDING/REPRODUCING APPARATUS, OPTICAL INFORMATION REPRODUCING APPARATUS, AND OPTICAL INFORMATION RECORDING/REPRODUCING METHOD

(75) Inventors: Kazuo Takahashi, Saitama (JP); Kiyoshi Tateishi, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/295,563

(22) PCT Filed: Mar. 29, 2007
(86) PCT No.: PCT/JP2007/056844

§ 371 Date: Sep. 30, 2008

(30) Foreign Application Priority Data
Mar. 31, 2006 (JP) 2006-099564

(51) Int. Cl. G11B 7/00

(52) U.S. Cl. 369/47.15; 369/103

(57) ABSTRACT

A focal follow-up control circuit performs follow-up control for a focal point on the data recording/reproducing region by reciprocating an object lens provided in a pickup with respect to a rotating direction of a data recording/reproducing region of an optical disk. The focal follow-up control circuit outputs a focal follow-up deviation signal indicative of a deviation between a follow-up central position of the object lens and a movable neutral point to a spindle control circuit. The spindle control circuit carries out feedback control of a number of rotations of a spindle motor so as to bring this focal follow-up deviation signal to zero.

### CROSS-REFERENCE TO RELATED APPLICATION

This application is based on Japanese Patent Application No. 2006-099564 filed on Mar. 31, 2006, the contents of which is incorporated hereinto by reference.

### BACKGROUND OF THE INVENTION

1. Field of the Invention

The present invention relates to an optical information recording/reproducing apparatus, an optical information reproducing apparatus, and an optical information recording/reproducing method that record or reproduce optical information of, e.g., a hologram in a recording medium such as an optical disk and so on.

2. Description of the Related Art

A hologram in which two-dimensional signals can be recorded at a high density attracts attention for high-density information recording. A feature of this hologram is to three-dimensionally record a wave front of light that carries recorded information as a change in refraction factor on a recording medium formed of a photosensitive material such as a photorefractive material and so on. For example, in JP, A, 1999-311937, a recording/reproducing apparatus is developed utilizing a hologram recording medium as a disk (a hologram disk).

In this hologram recording/reproducing apparatus, reference light is applied from an optical head, transmitted through a recording layer, and converged on a reflection layer as a spot so that the reference light reflected by the reflection layer can be diffused to be transmitted through the recording layer and signal light which is applied from the same optical head and carries information to be recorded can be transmitted through the recording layer. As a result, in the recording layer the reflected reference light and the signal light interfere with each other and an interference pattern is formed, thereby recording a hologram in the recording layer. Also, by irradiating a hologram recording medium with the reference light, and detecting and demodulating reproducing light from each hologram, it is possible to reproduce recorded information.

However, in case a general semiconductor laser is utilized as a light source, even irradiating a certain fixed position on the rotating optical disk with the reference light and the signal, there is a problem that it is difficult to supply exposure energy sufficient to shortly record information using the interference pattern in one data recording/reproducing region.

Then, for example, JP, A, 2005-203095 discloses a structure in which by driving an optical head in a manner that reference light and signal light can follow up and be applied to each data recording/reproducing region on an rotating optical disk for a certain fixed time, it is possible to assure a long exposure time in each data recording/reproducing region, thereby supplying sufficient exposure energy.

In the above explained prior art, due to unevenness of the optical disk in rotation by recording medium driving means, an accuracy limit of rotation control, or a restriction on follow-up control enabled range of an optical disk and the like, an irradiation position of the reference light and the signal light on the optical disk is not necessarily sufficiently maintained constant by the follow-up control. Thus, there is room to improve stability and certainty about the irradiation follow-up control.

The above described problem is given as one of examples of problems solved by the present invention.

### SUMMARY OF THE INVENTION

To solve the problem, the invention according to claim 1 provides an optical information recording/reproducing apparatus that performs recording/reproduction on a recording medium by irradiating the recording medium adopting an information recording mode utilizing holography with a recording/reproduction light beam, comprising: a recording medium driving unit that moves the recording medium; an optical head for irradiating the recording medium with the recording/reproduction light beam; a detecting unit that detects an irradiation position of the recording/reproduction light beam emitted from the optical head; an irradiation follow-up controlling unit that executes follow-up control for moving the irradiation position with following up movement of the recording medium for at least a fixed period based on a detection result of the detecting unit; and a recording medium controlling unit that controls driving of the recording medium driving unit in cooperation with the follow-up control performed by the irradiation follow-up controlling unit.

To solve the problem, the invention according to claim 9 provides an optical information reproducing apparatus that performs reproduction on a recording medium by irradiating the recording medium adopting an information recording mode utilizing holography with a reproduction light beam, comprising: a recording medium driving unit that moves the recording medium; an optical head that irradiates the recording medium with the reproduction light beam; a detecting unit detects an irradiation position of the reproduction light beam emitted from the optical head; an irradiation follow-up controlling unit that executes follow-up control to move the irradiation position with following up movement of the recording medium for at least a fixed period based on a detection result of the detecting unit; and a recording medium controlling unit that controls driving of the recording medium driving unit in cooperation with the follow-up control performed by the irradiation follow-up controlling unit.

To solve the problem, the invention according to claim 10 provides an optical information recording/reproducing method for performing recording/reproduction on the recording medium by moving the recording medium adopting an information recording mode utilizing holography and irradiating the moving recording medium with a recording/reproduction light beam, comprising: a step for detecting an irradiation position of the recording/reproduction light beam; and a step for causing the irradiation position to follow up movement of the recording medium for at least a fixed period based on a detection result of the irradiation position, and controlling driving of the recording medium in cooperation with the follow-up.

### BRIEF DESCRIPTION OF THE DRAWINGS

FIG. 1 is a block diagram showing an entire structure of a servo control section in a hologram recording/reproducing apparatus according to an embodiment of the present invention;

FIG. 2 is a view schematically showing structures of a pickup and an optical disk and an arrangement of a light path during hologram recording;

FIG. 3 is a view schematically showing the structures of the pickup and the optical disk and an arrangement of a light path during hologram reproduction;

FIG. 4 is top views each showing an appearance of a biaxial actuator from an axial direction;

FIG. 5 is a view showing changes in follow-up operation of an object lens and in focal follow-up driving signal with time in case a spindle motor is adequately operated;

FIG. 6 is a view showing changes in simplified follow-up operation position of the object lens with time and an appearance of the biaxial actuator associated with each follow-up operation position;

FIG. 7 is a view schematically showing changes in movement position of the object lens and in focal follow-up driving signal with time in case a follow-up central position deviates toward a follow-up direction from a movable neutral point;

FIG. 8 is a view schematically showing changes in movement position of the object lens and in focal follow-up driving signal with time in case the follow-up central position deviates toward a restoring direction from the movable neutral point;

FIG. 9 is a view schematically showing changes in movement position of the object lens with time in case a number of rotations of the spindle motor is high;

FIG. 10 is a view schematically showing changes in movement position of the object lens with time in case a focal follow-up deviation signal is fed back to spindle control;

FIG. 11 is a functional block diagram showing a functional structure of a spindle control circuit in the embodiment;

FIG. 12 is a flowchart showing a control procedure of a hologram recording operation executed by a main controller in the hologram recording/reproducing apparatus;

FIG. 13 is a functional block diagram showing a functional structure of a spindle control circuit in a variation where a reference voltage for spindle control is generated based on a number of rotations of a spindle motor; and

FIG. 14 is a view schematically showing changes in movement position of an object lens and in focal follow-up driving signal with time in a variation where a standby period is provided in focal follow-up control.

### DETAILED DESCRIPTION OF THE PREFERRED EMBODIMENTS

The following describes an embodiment of the present invention with reference to accompanying drawings.

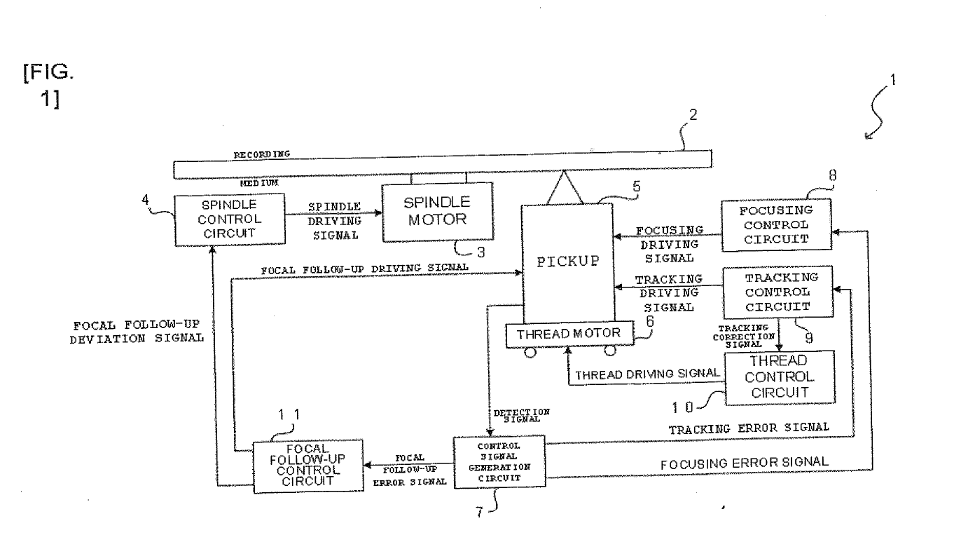

FIG. 1 is a block diagram showing an entire structure of a servo control section in a hologram recording/reproducing apparatus in the present embodiment.

On the side note, in the present embodiment, an optical disk having a disk shape is utilized as a recording medium and hologram multiple recording and reproduction are executed on the optical disk that is fixed to a rotary shaft of a spindle motor and driven to rotate. Also, this can be likewise applied to each of the below explained variations.

In FIG. 1, a hologram recording/reproducing apparatus 1 comprises an optical disk 2 as a recording medium, a spindle motor 3 which drives this optical disk 2 to rotate, a spindle control circuit 4 which controls driving of this spindle motor 3, a pickup 5 which receives application of a recording/reproduction light beam La to the optical disk 2 and reflected light of this beam, a thread motor 6 which holds this pickup 5 and moves it in a radial direction of the optical disk 2, a control signal generation circuit 7 which generates an error signal in each driving direction based on a serve detection signal (which will be explained later in detail) from the pickup 5, a focusing control circuit 8 which controls driving of the pickup 5 in a focusing direction (which will be explained later in detail), a tracking control circuit 9 which controls driving of the pickup 5 in a tracking direction (which will be explained later in detail), a thread control circuit 10 which controls driving of the thread motor 6, and a focal follow-up control circuit 11 which controls driving of the pickup 5 in a tangential direction (which will be explained later in detail). Each circuit is controlled by a not shown main controller (CPU).

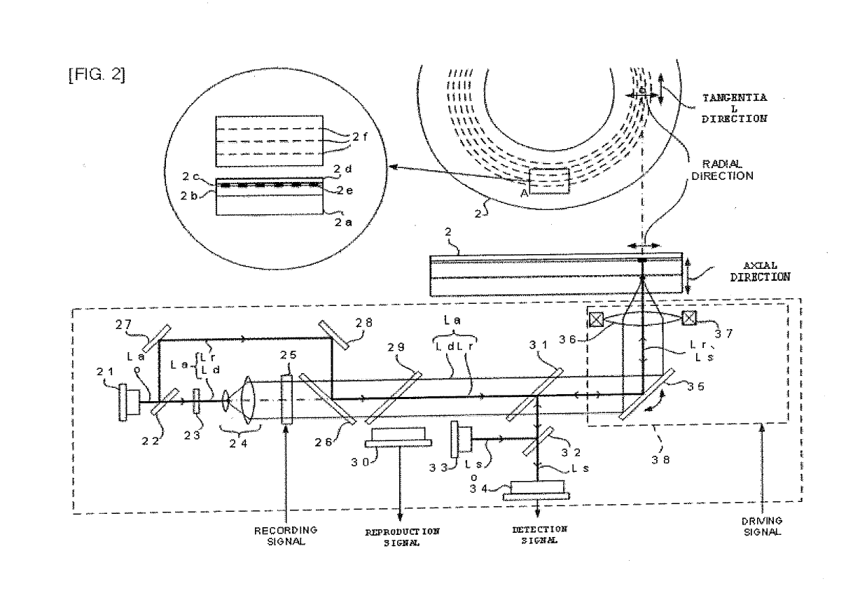

At first, in this situation, structures of the pickup 5 and the optical disk 2 will be first explained in detail. FIG. 2 is a view schematically showing structures of the pickup 5 and the optical disk 2 and an arrangement of a light path during hologram recording. On the side note, the drawings in a circle are an enlarged view and a cross-sectional view of a part A.

In this FIG. 2, the pickup 5 has a recording/reproduction laser 21, a beam splitter 22, a shutter 23, a beam expander 24, a spatial light modulator 25, a first half mirror 26, a first mirror 27, a second mirror 28, a second half mirror 29, a reproduction detector 30, a dichroic mirror 31, a third half mirror 32, a servo laser 33, a servo detector 34, a movable mirror 35, an object lens 36, and a biaxial actuator 37. Of these members, the movable mirror 35, the object lens 36, and the biaxial actuator 37 constitute a triaxial actuator 38.

The recording/reproduction laser 21 is a light source of signal light and reference light (both of which will be appropriately referred to as recording/reproduction light beams La hereinafter) for hologram recording and reproduction, and a semiconductor laser which emits a bluish-purple recording/reproduction laser beam Lao having a wavelength of, e.g., 405 nm is utilized. The servo laser 33 is a light source of a servo light beam Ls for controlling driving of the triaxial actuator 38, and a semiconductor laser which emits a red servo laser beam Lso having a wavelength of, e.g., 650 nm is utilized. The recording/reproduction laser 21 and the servo laser 33 are controlled by a not shown laser driver which transmits/receives various kinds of control signals including, e.g., a timing signal to/from the main controller.

The optical disk 2 is fixed to (or may be attachable to/detachable from) a rotary shaft of the spindle motor 3 and driven to rotate. Moreover, as a structure of the optical disk 2, a recording layer 2a, a servo layer 2b, a reflection layer 2c, and a protective layer 2d are sequentially laminated and formed on a substrate made of, e.g., a resin or glass. As the recording layer 2a, a photosensitive material such as a polymer or a lithium niobate single crystal which is a photorefractive material is used. A plurality of pits 2e are concentrically (or spirally) arranged on the reflection layer 2c, and positioning tracks 2f are formed in the servo layer 2b along pit rows.

During hologram recording, the servo light beam Ls is condensed on the positioning track 2f on the servo layer 2b. At this time, condensing positions of the servo light beam Ls and the recording/reproduction light beam La are determined by the same object lens 36, and the recording/reproduction light beam La is condensed on the recording layer 2a with a fixed shift amount (a deviation in a thickness direction of the optical disk 2) from the positioning track 2f of the servo layer 2b on which the servo light beam Ls is condensed, thereby recording a hologram.

Additionally, while performing hologram reproduction, if the servo light beam Ls is condensed on the positioning track 2f of the servo layer 2b, the recording/reproduction light beam La (reference light alone as will be explained later) is condensed on a predetermined data recording/reproducing region of the recording layer 2a, and a hologram is reproduced by utilizing reflected light of the condensed light. Therefore, a material with wavelength selection properties which allows the recording/reproduction light beam La to penetrate with a transmission factor having a predetermined value or above and reflects the servo light beam Ls with a reflection factor having a predetermined value or above is used for the servo layer 2b, the reflection layer 2c, and the pits 2e. As a result, the recording/reproduction light beam La is transmitted and the servo light beam Ls is reflected, and hence the positioning track 2f on the servo layer 2b that controls a condensing position does not affect recording and reproduction of a hologram in the recording layer 2a at all.

The recording/reproduction laser beam Lao emitted from the recording/reproduction laser 21 is divided into signal light Ld and reference light Lr by the beam splitter 22. During hologram recording in the example, the shutter 23 allows the signal light Ld to penetrate, a beam diameter of this signal light Ld is expanded by the beam expander 24 to be formed as parallel light. This parallel light enters the spatial light modulator (SLM; Spatial Light Modulator) formed of a transmission type TFT liquid crystal panel (LCD).

This spatial light modulator 25 forms a two-dimensional bright-and-dark dot pattern based on a data signal, which should be recorded as a hologram. In more detail, a recording data signal formed of a one-dimensional digital signal string is converted into a two-dimensional data string by a not shown encoder, an error correction code is added to the converted data string to generate a two-dimensional data signal (a unit page system data signal), and driving the spatial light modulator 25 by a not shown SLM driver provided in the encoder using a driving signal based on the two-dimensional data signal enables forming a two-dimensional bright-and-dark dot pattern corresponding to a panel plane of the spatial light modulator 25.

By transmitting the signal light Ld which is parallel light through the two-dimensional bright-and-dark dot pattern formed in this spatial light modulator 25, the signal light is subjected to light modulation in accordance with the two-dimensional data signal. That is, the spatial light modulator 25 has a modulating treatment unit associated with each unit page (the two-dimensional data signal), and modulates the parallel light having a wavelength of 405 nm and coherency (i.e., the signal light Ld before modulation) by switching ON/OFF of transmission of light for each pixel (dot, pixel) in accordance with the two-dimensional data signal, thereby forming a signal light beam. More concretely, the spatial light modulator 25 passes the signal light Ld through in accordance with a logical value “1” of each bit in the two-dimensional data signal as an electric signal on a light path cross section of the signal light Ld, and blocks the signal light Ld in accordance with a logical value “0” of the same. As a result, electro-optical conversion based on contents of each bit in the two-dimensional data signal is executed, thus generating a signal light beam modulated as the signal light Ld of the unit page system corresponding to the two-dimensional data signal.

This signal light Ld including recording data is sequentially transmitted through the first half mirror 26, the second half mirror 29, and the dichroic mirror 31, and then reflected to by the movable mirror 35, whereby a light path of this light is deflected. The signal light Ld reflected by the movable mirror 35 is condensed on a recording position of the optical disk 2 by the object lens 36. That is, a dot pattern signal component in the signal light Ld is subjected to Fourier transformation to be condensed in the recording layer 2a of the optical disk 2.

On the other hand, the reference light Lr divided by the beam splitter 22 is deflected by the first mirror 27 and the second mirror 28 to be led to the first half mirror 26. The reference light Lr is reflected by the first half mirror 26 to overlap the signal light Ld, and it is led as the recording/reproduction light beam La to the optical disk 2 through the same light path as that of the signal light Ld. As a result, the reference light Lr crosses the signal light Ld in the recording layer 2a of the optical disk 2 to form an optical interference pattern, and this optical interference pattern is recorded in the recording layer 2a as a change in refractive index. As a result, hologram recording is carried out.

At the same time, the servo laser light Lso emitted from the servo laser 33 is sequentially reflected by the second half mirror 29 and the dichroic mirror 31 to overlap the recording/reproduction light beam La as the servo light beam Ls, and it is led to the optical disk 2 through the same light path. At this time, the object lens 36 condenses the servo light beam Ls together with the recording/reproduction light beam La (the signal light Ld and the reference light Lr) onto the optical disk 2. As explained above, the servo light beam Ls alone is reflected by the reflection layer 2c, and reflected light of this servo light beam Ls is sequentially reflected by the movable mirror 35 and the dichroic mirror 31, transmitted through the third half mirror 32, and enter the servo detector 34. Although not shown in detail, a light receiving part of this servo detector 34 is divided into four parts, and a detection signal changed into an electrical signal in accordance with a light receiving amount in each light receiving part can be obtained.

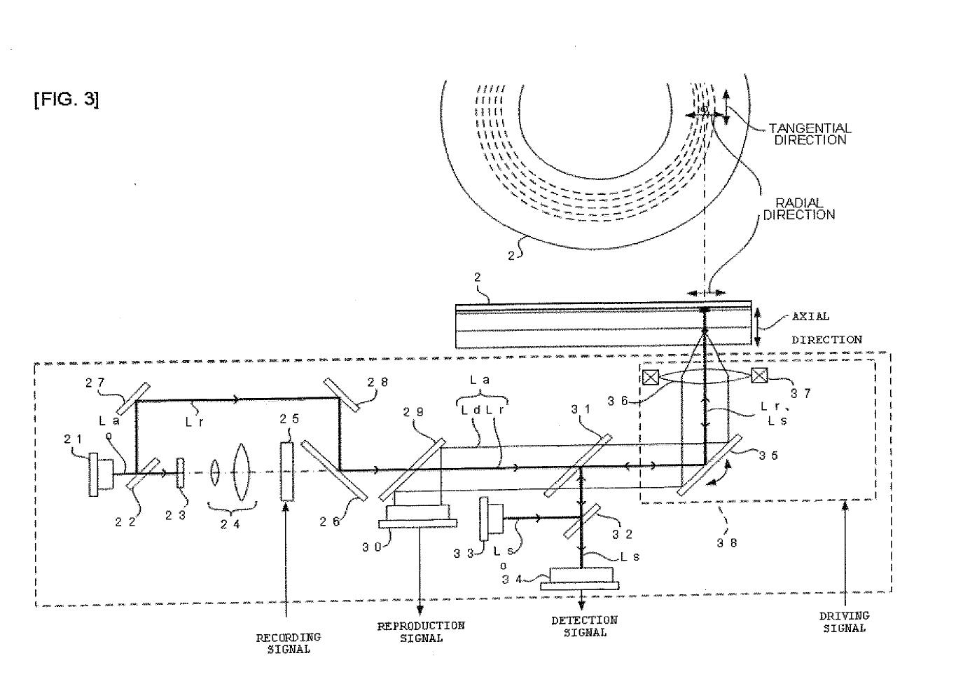

As explained above, a light path in the pickup 5 while performing hologram recording is formed. Next, FIG. 3 is a view schematically showing structures of the pickup 5 and the optical disk 2 and an arrangement of a light path during hologram reproduction.

In this FIG. 3, during hologram reproduction, the signal light Ld is blocked by the shutter 23 or the spatial light modulator 25, and the reference light Lr alone is led as the recording/reproduction light beam La to the optical disk 2 along the same light path as that in recording. The reference light Lr reflected by the reflection layer 2c becomes reproducing light that reproduces an optical interference pattern formed in the recording layer 2a to be led to the optical lens 36, and the reproducing light becomes parallel light including a bright-and-dark dot pattern corresponding to the optical interference pattern when the object lens 36 carries out inverse Fourier transformation at this moment. This reproducing light is reflected by the movable mirror 35, then transmitted through the dichroic mirror 31, reflected by the second half mirror 29, and received by the reproduction detector 30 formed of a charge-coupled device (CCD). This reproduction detector 30 reconverts an electrical two-dimensional data signal based on the bright-and-dark dot pattern included in the received reproducing light, and a not shown decoder reproduces a one-dimensional data signal. In this manner, hologram reproduction is carried out.

On the side note, a light path of the servo light beam Ls during this hologram reproduction is the same as that during the above described hologram recording, thereby an explanation about the light path during this hologram reproduction will be omitted.

In both recording and reproduction of the hologram, the triaxial actuator 38 can perform movement control over a focal position of the servo light beam Ls and a focal position of the recording/reproduction light beam La in order to condense and apply the servo light beam Ls to the positioning track 2f and also condense and apply the recording/reproduction light beam La to a predetermined data recording/reproducing region in association with planar blurring or a deviation at the time of rotation driving of the optical disk 2. In more detail, the triaxial actuator 38 can move a focal position along a thickness direction of the optical disk 2 (an X axis direction), a normal line direction of the positioning track 2f (a Y axis direction; a radial direction of the optical disk 2), and a tangential direction (a Z axis direction) of the positioning track 2f. In this example, this movement is effected by moving the object lens 36 and the movable mirror 35 in the triaxial actuator 38 shown in FIG. 2 and FIG. 3. Note that the thickness direction of the optical disk 2 will be referred to as an axial direction, the normal line direction of the positioning track 2f will be referred to as a radial direction, and the tangential direction of the positioning track 2f will be referred to as a tangential direction hereinafter.

In the example depicted in FIG. 2 and FIG. 3, the biaxial actuator 37 is driven to move the object lens 36 so that a focal point is moved in the axial direction and the tangential direction. Moreover, when the movable mirror 35 is rotated around a rotary axis in the tangential direction by not shown recording medium driving means, a focal point is moved in the radial direction. However, the method of moving a focal point is not restricted thereto. For example, the biaxial actuator 37 may move the object lens 36 in the axial direction and the radial direction and rotate the movable mirror 35 around the rotary axis in the radial direction. Additionally, a focal point may be moved based on any other combination. For example, besides the movable mirror 35, a piezoelectric actuator or a linear motor may be used to move the entire biaxial actuator 37 so that a focal point can be moved in the three axis directions.

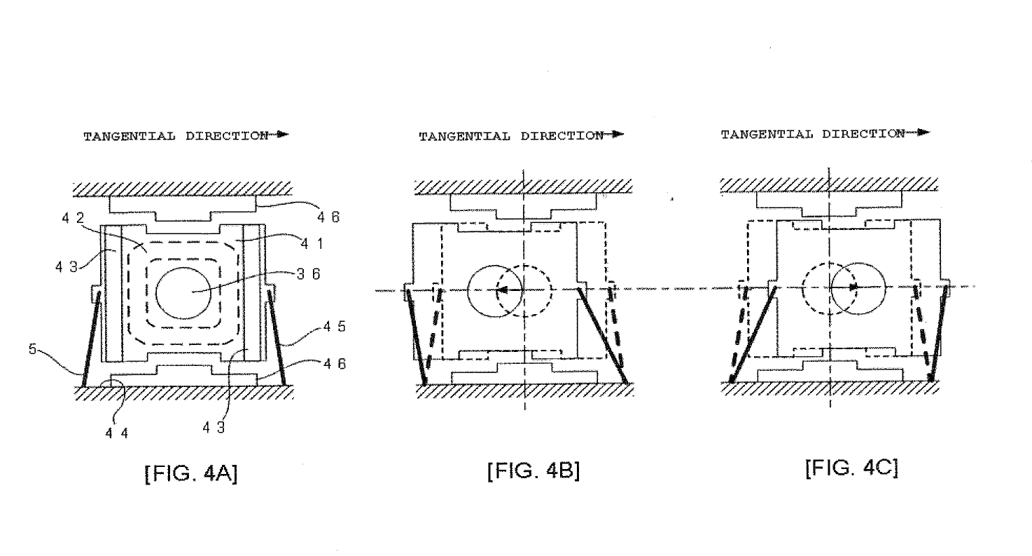

In this situation, the biaxial actuator 37 will be explained in detail with reference to FIG. 4. FIG. 4 shows top views each showing an appearance of the biaxial actuator 37 from the axial direction. FIG. 4A is a view where the biaxial actuator 37 is placed at a neutral position in the tangential direction. FIG. 4B is a view where the same is placed at a position moved toward one side in the tangential direction. FIG. 4C is a view where the same is placed at a position moved toward the other side in the tangential direction. Note that, in FIG. 4, a lateral direction in the drawing matches with the tangential direction, and an explanation will be given as to an example where the positioning track 2f of the optical disk 2 is substantially parallel to the lateral direction in the drawing and the data recording/reproducing region is moved in a direction extending from the left-hand side toward the right-hand side.

In FIG. 4, the biaxial actuator 37 having the object lens 36 installed thereto has a bobbin 41 on which the object lens 36 is fixed, an axial direction driving coil 42 provided to the bobbin 41, a tangential direction driving coil 43 likewise provided to the bobbin 41, a suspension 45 which supports the bobbin 41 from a pickup base (a case of the pickup 5) 44, and a magnetic circuit 46 provided at a position where the bobbin 41 is held.

The object lens 36 is fixed at the center of the bobbin 41. Additionally, the axial direction driving coil 41 and the tangential direction driving coil 43 are wound around this bobbin 41 in parallel to two axes perpendicular to each other (the tangential direction driving coil 43 is illustrated in the form of a cross section in the axial direction). The suspension 45 supporting the bobbin 41 is formed of an elastic material and supports the bobbin 41 while adding resilience of returning the bobbin 41 to the neutral position depicted in FIG. 4A with respect to movement of the bobbin 41 in the tangential direction. The suspension 45 also functions as a feeder wire that individually feeds driving signals to the axial direction driving coil 42 and the tangential direction driving coil 43. The magnetic circuit 46 includes a permanent magnet or an electromagnet and is arranged at a predetermined position around the bobbin 41 to form a magnetic force line.

With the above explained arrangement, by supplying a driving signal to the respective coils 42 and 43 via the suspension 45, an attraction force and a repulsive force function to the respective coils 42 and 43 due to an influence of the magnetic force line formed by the magnetic circuit 46 so that the bobbin 41 is driven to move against the resilience of the suspension 45. In this example, supplying the driving signal to axial direction driving coil 42 enables moving the bobbin 41 and the object lens 36 in the axial direction (a direction perpendicular to a page space of the drawing) in accordance with a positive/negative sign and a magnitude of the driving signal. As a result, focusing control can be performed to form a focal point of the servo light beam Ls on the reflection layer 2c of the recording medium in accordance with, e.g., plane blurring of the optical disk 2.

Moreover, in this example, a later-explained focal follow-up driving signal is supplied to the tangential direction driving coil 43. As a result, the bobbin 41 and the object lens 36 can be moved in the tangential direction (the lateral direction in the drawing) in accordance with a polarity (a sign) and a magnitude of an absolute value of this focal follow-up driving signal. Consequently, a condensing position of the recording/reproduction light beam La and a focal point of the servo light beam Ls can be subjected to follow-up control (which will be explained later in detail) with respect to movement of the data recording/reproducing region involved by rotation of the optical disk 2 along the tangential direction (along the positioning track 2f). Particularly, in this example, supplying the focal follow-up driving signal having a negative value to the tangential direction driving coil 43 enables moving the bobbin 41 in a direction opposite to the tangential direction (an opposite side of a moving direction of the data recording/reproducing region) as shown in FIG. 4B. Supplying the focal follow-up driving signal having a positive value to the tangential direction driving coil 43 enables moving the bobbin 41 in a forward direction of the tangential direction (a moving direction side of the data recording/reproducing region) as shown in FIG. 4C.

In this example, by rotating the movable mirror 35 (although not explained in particular, a galvano mirror is preferable to be used) around the rotary axis in the tangential direction as explained above enables moving a condensing position of the recording/reproducing light beam La and a focal point of the servo light beam Ls in the radial direction. As a result, radial control can be performed to move the focal point in the radial direction in accordance with, e.g., a deviation of the optical disk 2 or track pitch unevenness.

In this situation, referring back to FIG. 1, the servo control will be explained in detail. The control signal generation circuit 7 uses a servo detection signal obtained from the servo detector 34 of the pickup 5 to generate a focusing error signal indicative of a deviation between the reflection layer 2c of the optical disk 2 and a focal point in the axial direction and a tracking error signal indicative of a deviation between the positioning track 2f and a focal point. In regard to generation of the focusing error signal, astigmatism is detected by a not shown cylindrical lens based on a deviation of a focal point from the reflection layer 2c of the optical disk 2, and this astigmatism is used to perform generation (Astigmatic method). Regarding to generation of the tracking error signal, diffracted light is produced based on a deviation of a focal point from the positioning track 2f provided along each pit 2e in the reflection layer 2c of the optical disk 2, and this diffracted light is utilized to effect generation.

These error signals are input to the focusing control circuit 8 and the tracking control circuit 9, respectively. The focusing control circuit 8 and the tracking control circuit 9 drive the biaxial actuator 37 and the movable mirror 35 (the triaxial actuator 38) of the pickup 5 in such a manner that each of the focusing error signal and the tracking error signal becomes zero, and execute focusing control and tracking control to form a focal point on the appropriate positioning track 2f.

In regard to the tracking control, in case the focal point must be greatly moved in the tracking direction, the entire pickup 5 is moved in the radial direction using the thread motor 6 so that the focal point can be moved within a movable range of the movable mirror 35. The thread control circuit 10 uses a low-frequency band component in the tracking driving signal or the tracking error signal to execute thread control so that the low-frequency band component in the tracking driving signal or the tracking error signal becomes zero.

In the example in the present embodiment, the control signal generation circuit 7 generates a focal follow-up error signal except for the focusing error signal and the tracking error signal. The control signal generation circuit 7 produces the focal follow-up error signal based on diffracted light generated when the servo light beam Ls is transmitted through each pit 2e formed along the positioning track 2f when a focal point traces the predetermined positioning track 2f. Moreover, the focal follow-up control circuit 11 drives and controls the biaxial actuator 37 in the tangential direction based on the focal point error signal in such a manner that a focal point follows up the focal follow-up pit 2e for at least a fixed time. Meanwhile, a focal point of the servo light beam Ls is controlled to be stationary on a given pit 2e. As a result, a condensing position of the recording/reproduction light beam La becomes stationary with respect to a given rotating data recording/reproducing region which rotates and moves. This operation is called focal follow-up. When this follow-up operation is carried out, a long exposure time can be assured and sufficient exposure energy can be supplied with respect to one data recording/reproducing region even though a light beam with rather small energy from, e.g., a semiconductor laser is used. As a result, information can be recorded at a relatively high speed by using a realistic recording medium and a light source.

At this time, since there is a limit in a mechanical driving range of the actuator with respect to the tangential direction, it is impossible to infinitely keep on performing focal follow-up. Thus, after the follow-up operation is carried out with respect to a given data recording/reproducing area for a fixed time alone, the focal follow-up is once stopped, the object lens 36 is driven in a direction opposite to the rotating direction of the optical disk 2, and then the focal follow-up is again performed with respect to the next data recording/reproducing area. Therefore, the object lens 36, the focal point of the servo light beam Ls, and the condensing position of the recording/reproduction light beam La follow up movement of the data recording/reproducing region while repeating reciprocation in the tangential direction.

In the hologram recording/reproducing apparatus 1 in the present embodiment, the focal follow-up control circuit 11 inputs a low-frequency band component of the focal follow-up driving signal or the focal follow-up error signal to the spindle control circuit 4 as a focal follow-up deviation signal. This focal follow-up deviation signal is a signal indicating how much an average deviation in the tangential direction, i.e., a central position of the reciprocation of the object lens 36 in the tangential direction (which will be referred to as a follow-up central position hereinafter) deviates from a movable neutral point of the biaxial actuator 37.

By adequately forming a focal point on the predetermined positioning track 2f based on the focusing control and the tracking control while the spindle motor 3 rotates the optical disk 2, a tracing operation in the data recording/reproducing region is performed. At this time, the spindle control circuit 4 sets a follow-up central position in the tangential direction of the biaxial actuator 37 to which the object lens 36 is fixed to a position near the movable neutral point of the biaxial actuator 37 by effecting feedback control of a rotating speed of the spindle motor 3 in such a manner that the focal follow-up deviation signal becomes close to zero.

Such a focal follow-up operation will be explained in detail hereinafter.

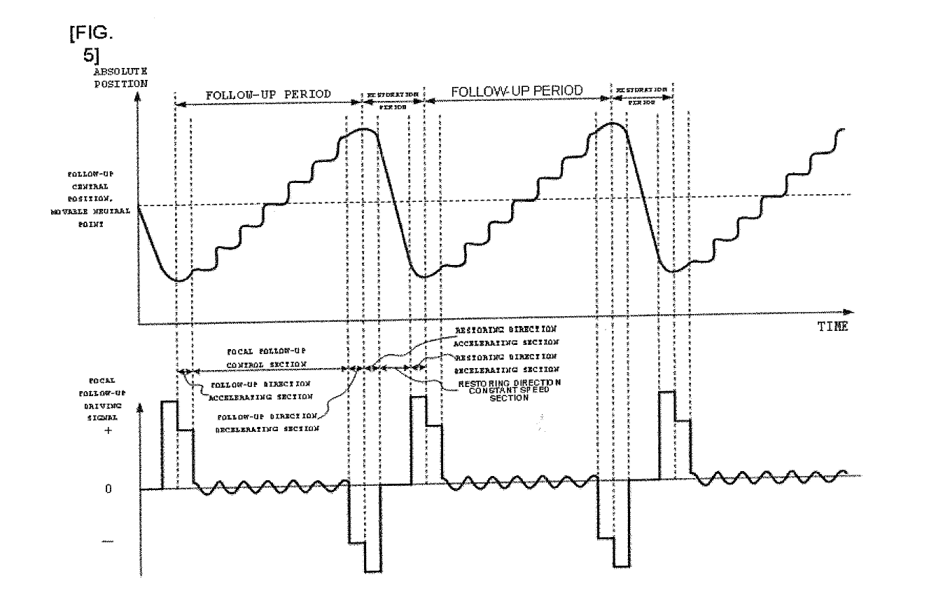

FIG. 5 is a view showing changes in follow-up operation position of the object lens 36 with time and changes in focal follow-up driving signal with time when the spindle motor 3 adequately operates. On the side note, an upper part in the drawing shows changes in movement position of the object lens 36 with time at an absolute position in the tangential direction (=a position of the object lens 36 in the actuator 37 at the time of follow-up operation or repeated driving), and a lower part in the same shows changes in focal follow-up driving signal with time.

In this FIG. 5, an inclination of a curve in the upper part generally becomes positive while the object lens 36 moves in the follow-up direction, a period where the object lens 36 moves in this direction is called a follow-up period, and a period where the object lens 36 moves in the opposite direction is called a restoration period. At the time of recording/reproduction, the object lens 36 is reciprocated while repeating these follow-up period and restoration period.

In the follow-up period, in order to follow up the data recording/reproducing region of the optical disk 2, at first, the focal follow-up driving signal having a positive value is supplied to the tangential direction driving coil 43 of the biaxial actuator 37 in a follow-up direction accelerating section to effect acceleration driving and run-up in the follow-up direction. Next, feedback control is performed so that the focal follow-up error signal becomes close to zero in a focal follow-up control section. As a result, in the focal follow-up control section, data can be recorded/reproduced while effecting follow-up so that a focal point can highly accurately match with the data recording/reproducing region even if there is a deviation in the tangential direction (caused due to a deviation of the optical disk 2). Moreover, assuring a fixed recording/reproducing time in this focal follow-up control section enables securely recording/reproducing data. Additionally, after recording/reproduction is completed in this focal follow-up control section, deceleration driving of the object lens 36 is carried out by supplying the focal follow-up driving signal having a negative value in a follow-up direction decelerating section to terminate movement in the follow-up direction.

To restore a position of the object lens 36 in the restoration period, the focal follow-up driving signal having a negative value is supplied in a restoring direction accelerating section to execute acceleration driving in a direction (a restoring direction) opposite to the follow-up direction. Then, when power feeding of the focal follow-up driving signal is stopped, the object lens 36 moves in a restoring direction constant speed section at a constant speed due to dynamic characteristics of the biaxial actuator 37 (dynamic characteristics of the suspension 45). Next, after elapse of a predetermined time, deceleration driving of the object lens 36 is carried out by supplying the focal follow-up driving signal having a positive value in a restoring direction decelerating section to terminate movement in the restoring direction. A movement speed of the object lens 36 is sufficiently reduced in this state, and the follow-up operation is again started when the next data recording/reproducing region is detected.

Ideally, as shown in FIG. 5, it is desirable that the next data recording/reproducing region arrives immediately after end of the restoring section and acceleration in the follow-up direction is executed after deceleration in the restoring direction. In this situation, since the respective movement directions, i.e., the follow-up direction and the restoring direction are opposite, polarities of the respective focal follow-up driving signals at the time of acceleration driving in the follow-up direction and deceleration driving in the restoring direction are equal to each other (positive), and polarities of the respective focal follow-up driving signals at the time of deceleration driving in the follow-up direction and acceleration driving in the restoring direction are equal to each other (negative).

A length of the follow-up section is set to a length that enables sufficiently assuring an irradiation amount of the recording/reproduction light beam La on the optical disk 2. A follow-up speed (a rotating speed of the optical disk 2) is set from the length of the follow-up section and a movable range of the biaxial actuator 37, and magnitudes of absolute values of the respective focal follow-up driving signals at the time of acceleration driving and deceleration driving in the follow-up section are set. Moreover, the object lens 36 can be quickly restored (a movement speed in the restoring section is high and an inclination of the curve in the upper part in FIG. 5 becomes negative and precipitous) by setting large absolute values of the respective focal follow-up driving signals at the time of acceleration driving and deceleration driving in the restoring section. As a result, each interval between the data recording/reproducing regions in the optical disk 2 can be reduced, thereby improving a recording density of the optical disk 2.

Additionally, in the above explained ideal state, an acceleration amount in acceleration driving and a deceleration amount in deceleration driving in the respective periods are set to have opposite polarities and substantially equal absolute values, and averages of these values become substantially zero. If the object lens 36 performs the follow-up operation around the movable neutral point of the biaxial actuator 37, an average of driving amounts in the focal follow-up control section becomes zero.

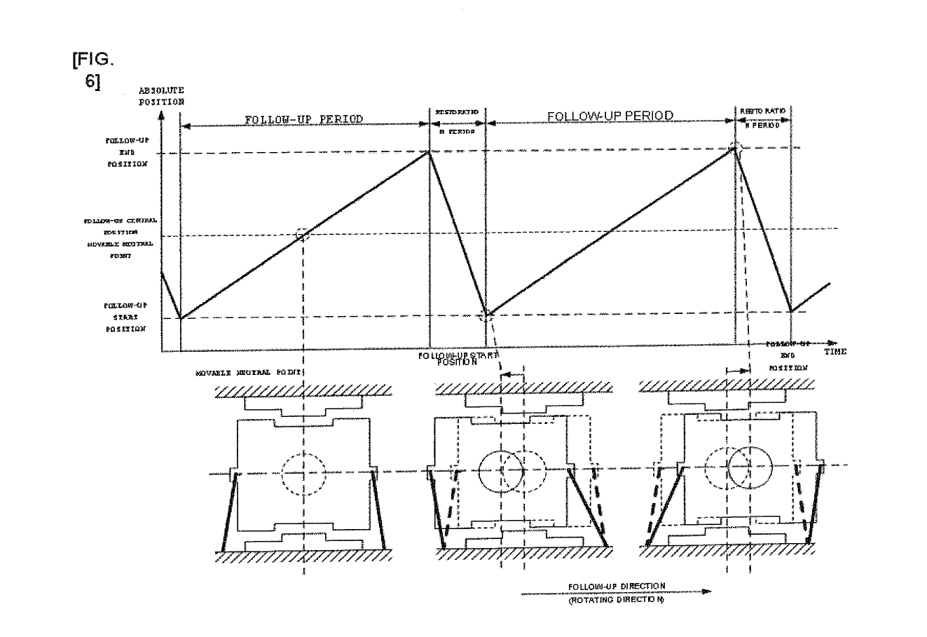

Thus, when an average value of driving amounts (an average value of absolute positions) of the object lens 36 in the respective periods is used to set times in each acceleration driving and each deceleration driving to be sufficiently short against the follow-up time, changes in movement position of the object lens 36 with time at an absolute position in the tangential direction can be represented by using such a simplified curve as shown in FIG. 6. On a side note, a lower part in FIG. 6 shows appearances of the biaxial actuator 37 in states associated with respective follow-up operation positions. In this situation, the movable neutral point means a position where the object lens 36 remains stationary by resilience of the suspension 45 in a state in which a sufficient time has elapsed with the focal follow-up driving signal being set to zero (with no load). Additionally, in this situation, a central position of reciprocation of the object lens 36 is called a follow-up central position.

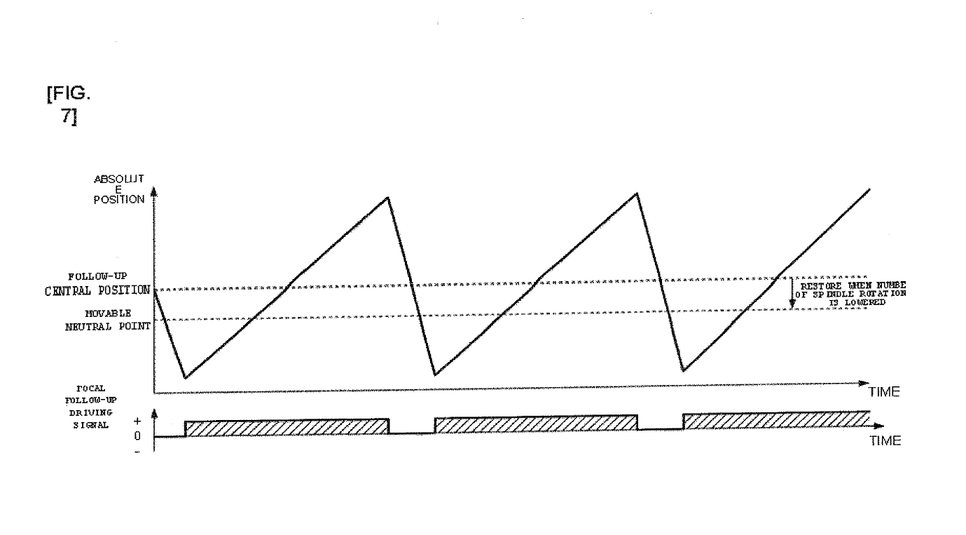

FIG. 7 is a view schematically showing changes in movement position of the object lens 36 and in focal follow-up driving signal with time in case the follow-up central position deviates from the movable neutral point toward the follow-up direction for some reason. In this FIG. 7, an average value of the focal follow-up driving signals in the focal follow-up control section represents supply of a signal having a positive value in order to maintain the movement central position against resilience of the suspension 45. At this time, if control is performed to reduce a number of rotations of the spindle motor 3, the follow-up central position moves closer to the movable neutral point.

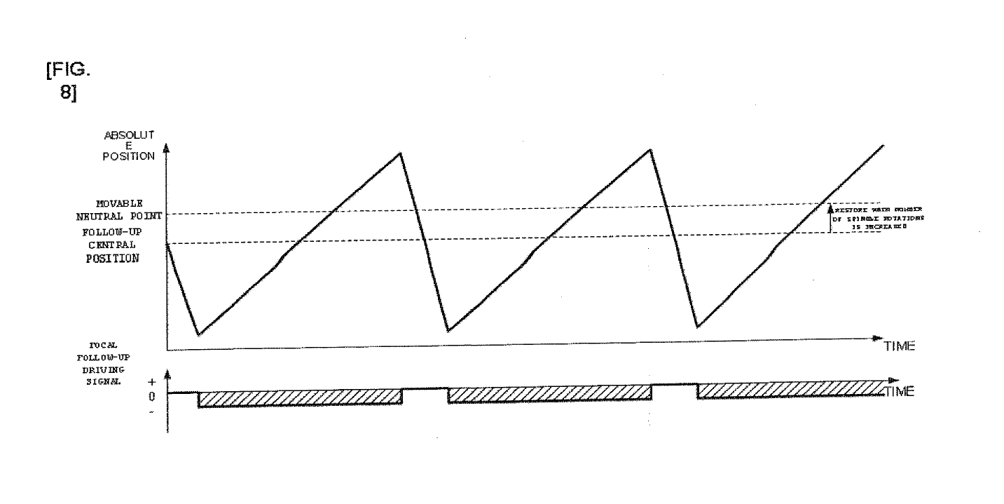

FIG. 8 is a view schematically showing changes in movement position of the object lens 36 and in focal follow-up driving signal with time when the follow-up central position deviates from the movable neutral point toward the restoring direction for some reason. In this FIG. 8, an average value of the focal follow-up driving signals in the focal follow-up control section represents supply of a signal having a negative value in order to maintain the movement central position against resilience of the suspension 45. At this time, if controlled to increase a number of rotations of the spindle motor 3, the follow-up central position moves closer to the movable neutral point.

That is, it is possible to detect how much and which direction the follow-up central position deviates from the movable neutral point in proportion to the focal follow-up driving signal. Thus, the hologram recording/reproducing apparatus 1 in the present embodiment inputs this focal follow-up driving signal to the spindle control circuit 4 as a focal follow-up deviation signal, and the spindle control circuit 4 performs feedback control with respect to the number of rotations of the spindle motor 3 so as to set this focal follow-up deviation signal to zero, thereby enabling moving the follow-up central position to the movable neutral point.

As explained above, as to the focal follow-up of the object lens 36 with respect to movement of the data recording/reproducing region, it is preferable to reciprocate the object lens 36 around the movable neutral point of the biaxial actuator 37 in the tangential direction. That is, as shown in FIG. 6, a follow-up start position and a follow-up end position of the object lens 36 must respectively keep substantially equal separation distances against the movable neutral point of the biaxial actuator 37.

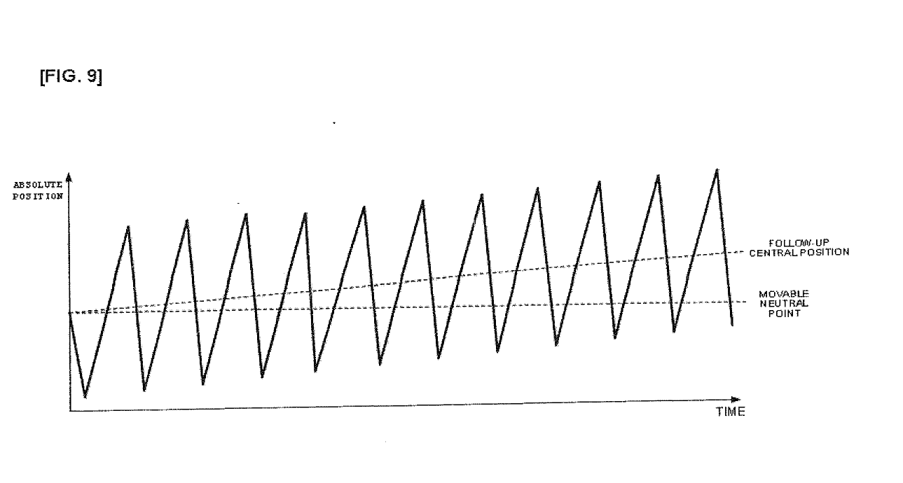

In this situation, a case is given as a comparative example that control concerning the follow-up control on the number of rotations of the spindle motor 3 is not performed at all. In case the number of rotations on the spindle motor 3 is even slightly greater than appropriate number of rotations, even making a condensing position of the recording/reproduction light beam La relatively followed up in the data recording/reproducing region, a behavior shown in FIG. 9 is only showed. That is, adequate control cannot be performed when the follow-up central position of the object lens 36 deviates to be gradually separated from the movable neutral point of the biaxial actuator 37 and the object lens 36 cannot eventually obtain an appropriate posture beyond an adequate movable range of the biaxial actuator 37 or mechanically interferes with any other optical component.

Even if the spindle motor 3 is rotated with an accurate number of rotations based on information reproduced form the optical disk 2, when a deviation once occurs between the follow-up central position and the movable neutral point for some reason, means for remedying this deviation is not present, and hence the recording/reproducing operation is continued while maintaining a state where the optical structure is inappropriately arranged and the control system is unstable. Since the focal follow-up where reciprocation is carried out in the tangential direction is executed, a speed for tracing, e.g., the pits 2e of the reflection layer 2c becomes discontinuous, and hence obtaining an appropriate reference clock is hard, thus making it difficult to accurately execute spindle control.

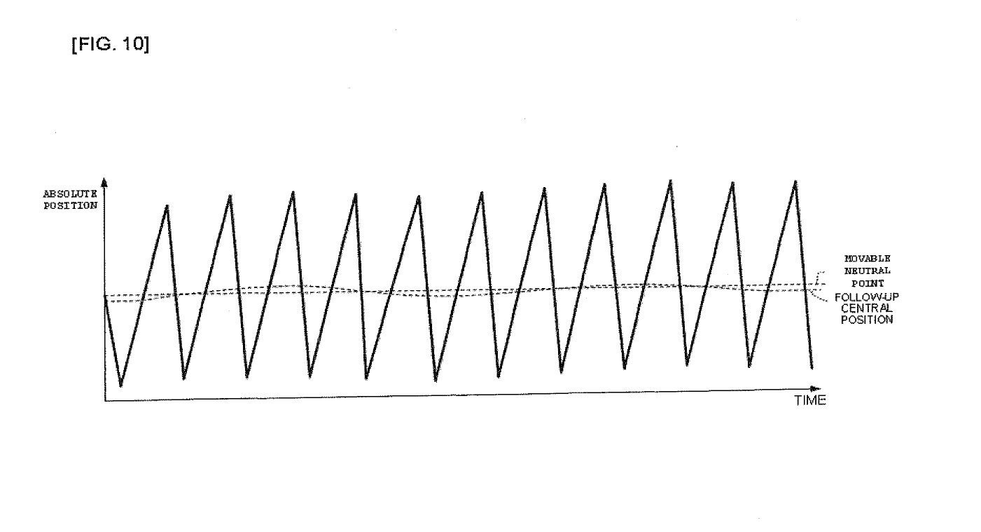

On the other hand, the hologram recording/reproducing apparatus 1 in the present embodiment feeds back the focal follow-up deviation signal to spindle control from the focal follow-up control circuit 11 (see FIG. 1). As a result, a biased state of the object lens 36 (a state where the follow-up central position and the movable neutral point greatly deviate from each other) can be solved, and the follow-up operation can be performed in such a manner that the object lens 36 keeps reciprocating around the movable neutral point of the biaxial actuator 37 as shown in FIG. 10. Therefore, data can be recorded/reproduced in a state where the optical system is adequate and the control system is stable.

When the feedback control using the focal follow-up deviation signal is not executed, since a timing for the focal follow-up operation is determined based on a number of rotations of the spindle motor 3 (a rotating speed of the optical disk 2), accurate rotation control is required, and signal processing and others based on disk information must be executed in the spindle control. The hologram recording/reproducing apparatus 1 in the present embodiment has an advantage that an operation timing can be automatically corrected by performing the spindle control and the focal follow-up control in cooperation with each other (synchronization, cooperation) and a relatively simple structure can be provided without requiring a high accuracy in both the controls.

A circuit configuration of the spindle control circuit 4 that performs feedback control over a number of rotations of the spindle motor 3 as described above will be explained.

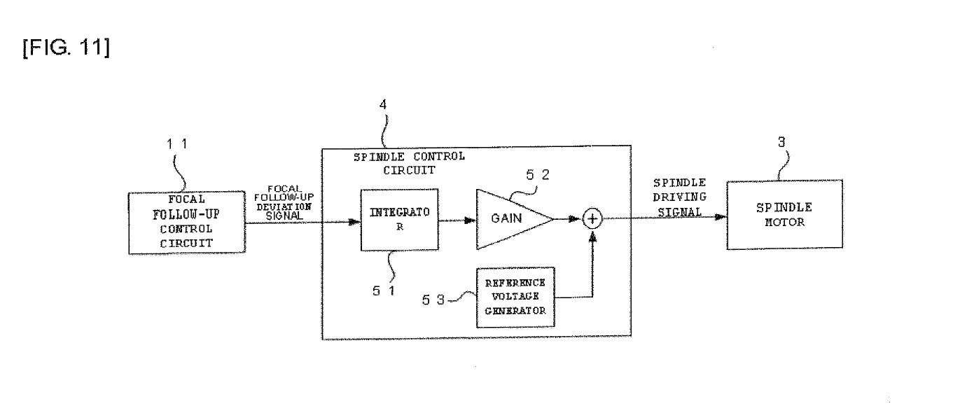

FIG. 11 is a functional block diagram showing a functional structure of the spindle control circuit 4 in the present embodiment. In this FIG. 11, the spindle control circuit 4 has an integrator 51 which integrates a focal follow-up deviation signal input from the focal follow-up control circuit 11, a first gain 52 which amplifies a signal output from this integrator 51, and a reference voltage generator 53 which generates a reference voltage associated with an appropriate number of rotations of the spindle. On the side note, a spindle motor whose number of rotations is controlled based on an input voltage is used as the spindle motor 3 in this example.

A focal follow-up deviation signal input from the focal follow-up control circuit 11 is subjected to time integral by the integrator 51 (basically formed of a low-pass filter) to be calculated as voltage associated with a bias amount of the object lens 36 (an amount corresponding to a deviation between the follow-up central position and the movable neutral point). This bias amount voltage is amplified with a predetermined magnification by the first gain 52, and then it is added to a reference voltage from the reference voltage generator 53 to be output to the spindle motor 3. As a result, the voltage increased/reduced from the reference voltage in accordance with a change in bias amount voltage is input to the spindle motor 3. Consequently, feedback control is executed over a number of rotations of the spindle motor 3 so as to bring the bias amount to zero.

It is to be noted that, since the focal follow-up driving signal and the focal follow-up error signal become signals having similar waveforms in the focal follow-up control section, both the signals may be utilized as the focal follow-up deviation signal. Moreover, when effecting constant linear speed control in control over rotation of the optical disk 2, the reference voltage serving as a reference for a number of rotations of the optical disk 2 is changed in accordance with a radial position of the optical disk 2 on which information is recorded/reproduced.

A control procedure in a hologram recording operation in the hologram recording/reproducing apparatus 1 having the above-described structure will be explained.

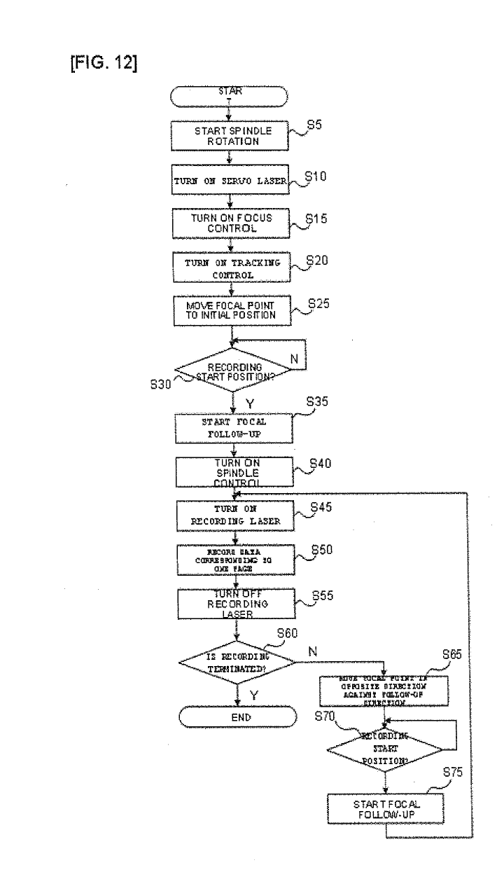

FIG. 12 is a flowchart showing a control procedure of a hologram recording operation executed by the main controller in the hologram recording/reproducing apparatus 1. In FIG. 12, for example, when an operation of starting the hologram recording operation in a not shown operating section is executed, this flow starts.

At first, at step S5, a control signal is outputted to the spindle control circuit 4 to start rotation of the spindle motor 3, and Next, moving to step S10.

At the step S10, a control signal is outputted to a not shown laser driver to turn on the servo laser 33.

Next, moving to step S15, and a control signal indicative of start of an operation is outputted to the focusing control circuit 8 to begin focusing control.

Next, moving to step S20, and a control signal indicative of start of an operation is outputted to the tracking control circuit 9 to begin tracking control. At this point in time, a focal point is formed on the predetermined positioning track 2f, and a tracing operation begins.

Next, moving to step S25, and the object lens 36 is driven in the tangential direction to move to an initial position by outputting a control signal to the focal follow-up control circuit 11 and inputting a focal follow-up driving signal to the biaxial actuator 37.

Next, moving to step S30, a standby mode continues until the focal point reaches a predetermined data recording/reproducing region where recording should be started, and moving to next step S35 when it is determined that the focal point has reached.

At the step S35, a control signal is outputted to the focal follow-up control circuit 11, and the focal follow-up driving signal is input to the biaxial actuator 37 to start follow-up operation in such a manner that the focal point is fixed in the data recording/reproducing region.

Next, moving to step S40, and a control signal is outputted to the spindle control circuit 4 to effect feedback control over a rotating speed of the spindle motor in such a manner that a focal follow-up deviation signal is brought to zero.

Next, moving to step S45, a control signal is outputted to the not shown laser driver and lighting of the recording/reproduction laser 21 is started.

Next, moving to step S50, by opening of the shutter 23, inputting recording data to a not shown encoder, and performing pattern control of the spatial light modulator 25, data corresponding to one page is recorded in the data recording/reproducing region which is being followed up.

Next, moving to step S55, a control signal is outputted to a not shown laser driver to turn off the recording/reproduction laser 21.

Next, moving to step S60, and whether data corresponding to all pages to be recorded has been completed is judged. When recording data corresponding to all pages has been completed, the judgment is satisfied, and this flow is terminated. On the other hand, when recording data corresponding to all pages is yet to be completed, the judgment is not satisfied, and the processing advances to step S65.

At step S65, a control signal is outputted to the focal follow-up control circuit 11 to output the focal follow-up driving signal to the biaxial actuator 37, and the focal point is moved in a direction opposite to the follow-up direction until the focal point reaches the next data recording/reproducing region.

Next, moving to step S70, a standby mode continues until the focal point reaches a predetermined data recording/reproducing region where recording should be started, and Next, moving to step S75 when it is determined that the focal point has reached.

At the step S75, a control signal is outputted to the focal follow-up control circuit 11, and the focal follow-up driving signal is input to the biaxial actuator 37, thereby starting a follow-up operation in such a manner that the focal point is fixed in the data recording/reproducing region. Moreover, the processing returns to the step S45 to repeat the same control procedure. Using the above explained flow enables effecting the hologram recording operation.

On the side note, the optical disk 2 is applied as a recording medium in the present embodiment, the present invention is not limited thereto. For example, it is possible to apply an optical recording medium having a card shape. In this case, a focal follow-up deviation signal is input to a control circuit that performs driving control over an actuator, e.g., a linear motor that drives a card in the tangential direction, thereby executing feedback control.

As explained above, the optical information recording/reproducing apparatus (the hologram recording/reproducing apparatus) 1 in the present embodiment is the optical information recording/reproducing apparatus 1 performs recording/reproduction on the recording medium 2 by irradiating the recording medium (the optical disk in this example) 2 adopting the information recording mode utilizing holography with the recording/reproduction light beam (the recording/reproduction light beam in this example) La, comprising: the recording medium driving unit (the spindle motor in this example) 3 that moves the recording medium 2; the optical head (the pickup in this example) 5 for irradiating the recording medium 2 with the recording/reproduction light beam La; the detecting unit (the servo detector in this example) 34 that detects an irradiation position of the recording/reproduction light beam La emitted from this optical head 5; the irradiation follow-up controlling unit (the control signal generation circuit 7, the focal follow-up control circuit 11, the magnetic circuit 46, and the tangential direction driving coil 43 in this example) that executes follow-up control for moving the irradiation position with following up movement of the recording medium 2 for at least a fixed time based on a detection result of this detecting unit 34; and the recording medium controlling unit (the spindle control circuit in this example) 4 that controls driving of the recording medium driving unit 3 in cooperation with the follow-up control executed by the irradiation follow-up controlling unit 7, 11, 46, and 43.

In the optical information recording/reproducing apparatus 1 in the present embodiment, the holography type recording medium 2 is driven by the recording medium driving unit 3, and the driven recording medium 2 is irradiated with the recording/reproduction light beam La from the optical head 5 to effect recording/reproduction (recording or reproduction of information) with respect to the recording medium 2. Additionally, the irradiation follow-up controlling unit 7, 11, 46, and 46 move the irradiation position while following up movement of the recording medium 2 based on a result of detecting the irradiation position of the recording/reproduction light beam La obtained by the detecting unit 34. As a result, irradiation can be carried out in a state where a relative irradiation position of the recording/reproduction light beam La on the recording medium 2 is maintained constant for at least a fixed period. As a result, recording/reproduction (recording or reproduction of information) can be executed at a relatively high speed with a beam output which not very large.

Further, even if there is a possibility that the irradiation position of the recording/reproduction light beam La on the recording medium 2 cannot be necessarily sufficiently maintained constant by the follow-up control alone performed by the irradiation follow-up controlling unit 7, 11, 46, and 43 due to driving (including rotation) unevenness of the recording medium driving unit 3, an accuracy limit of driving control, a restriction in a follow-up control enabled range, and others, follow-up control can be compensated when the recording medium controlling unit 4 controls driving of the recording medium driving unit 3 in cooperation with the follow-up control carried out by the irradiation follow-up controlling unit 7, 11, 46, and 43. As a result, the irradiation position of the recording/reproduction light beam La on the recording medium can be stably and assuredly maintained constant.

The optical information reproducing apparatus (the hologram recording/reproducing apparatus in this example) 1 in the present embodiment is the optical information reproducing apparatus 1 that performs reproduction on a recording medium by irradiating the recording medium (the optical disk in this example) 2 adopting the information recording mode utilizing holography with the reproduction light beam (the reference light in this example) Lr, comprising: the recording medium driving unit (the spindle motor in this example) 3 that moves the recording medium 2; the optical head (the pickup in this example) 5 that irradiates the recording medium 2 with the reproduction light beam Lr; the detecting unit (the servo detector in this example) 34 that detects an irradiation position of the reproduction light beam Lr emitted from this optical head 5; the irradiation follow-up controlling unit (the control signal generation circuit 7, the focal follow-up control circuit 11, the magnetic circuit 46, and the tangential direction driving coil 43 in this example) that executes follow-up control to move the irradiation position with following up movement of the recording medium 2 for at least a fixed period based on a detection result of this detecting unit 34; and the recording medium controlling unit (the spindle control circuit in this example) 4 that controls driving of the recording medium driving unit 3 in cooperation with the follow-up control executed by the irradiation follow-up controlling unit 7, 11, 46, and 43.

In the optical information reproducing apparatus 1 in the present embodiment, the holography type recording medium 2 is driven by the recording medium driving unit 3, and this driven recording medium 2 is irradiated with the reproduction light beam Lr from the optical head 5, thereby reproducing information on the recording medium 2. The irradiation follow-up controlling unit 7, 11, 46, and 43 move the irradiation position while following up movement of the recording medium 2 based on a result of detecting the irradiation position of the reproduction light beam Lr by the detecting unit 34. As a result, irradiation can be carried out in a state where a relative irradiation position of the reproduction light beam Lr on the recording medium 2 is maintained constant for at least a fixed period. Consequently, information can be reproduced at a relatively high speed with a beam output, which is not very large.

Moreover, even if there is a possibility that the irradiation position of the reproduction light beam Lr on the recording medium 2 cannot be necessarily sufficiently maintained constant by the follow-up control alone executed by the irradiation follow-up controlling unit 7, 11, 46, and 43 due to driving (including rotation) unevenness of the recording medium driving unit 3, an accuracy limit of driving control, a restriction in a follow-up control enabled range, and others, the follow-up control can be compensated when the recording medium controlling unit 4 controls driving of the recording medium driving unit 3 in cooperation with the follow-up control performed by the irradiation follow-up controlling unit 7, 11, 46, and 43. Consequently, the irradiation position of the reproduction light beam Lr on the recording medium 2 can be stably and assuredly maintained constant.

The optical information recording/reproducing method carried out in the optical information recording/reproducing apparatus (the hologram recording/reproducing apparatus in this example) 1 in the present embodiment is the optical information recording/reproducing method for performing recording/reproduction on the recording medium 2 by moving the recording medium (the optical disk in this example) 2 adopting the information recording mode utilizing holography and irradiating the moving recording medium 2 with the recording/reproduction light beam (the recording/reproduction light beam in this example) La, comprising: a step for detecting an irradiation position of the recording/reproduction light beam La, and a step for causing the irradiation position to follow up movement of the recording medium 2 for at least a fixed period based on a detection result of this irradiation position, and controlling driving the recording medium 2 in cooperation with this follow-up.

In the optical information recording/reproducing method carried out in the optical information recording/reproducing apparatus 1 in the present embodiment, the holography type recording medium 2 is moved, and the moving recording medium 2 is irradiated with the recording/reproduction light beam La to execute recording/reproduction (recording or reproduction of information) on the recording medium 2. Next, the irradiation position is caused to follow up movement of the recording medium 2 based on a result of detecting the irradiation position of the recording/reproduction light beam La. As a result, irradiation can be carried out in a state where a relative irradiation position of the recording/reproduction light beam La on the recording medium 2 is maintained constant for at least a fixed period. Consequently, recording/reproduction (recording or reproduction of information) can be executed at a relatively high speed with a beam output, which is not very large.

Moreover, even if there is a possibility that the irradiation position of the recording/reproduction light beam La on the recording medium 2 cannot be necessarily sufficiently maintained constant only by the follow-up control due to driving (including rotation) unevenness of the recording medium 2, an accuracy limit of driving control, a restriction in a follow-up control enabled range, and others, the follow-up control can be compensated by controlling driving the recording medium 2 in cooperation with the follow-up. Consequently, the irradiation position of the recording/reproduction light beam La on the recording medium 2 can be stably and assuredly maintained constant.

In the optical information recording/reproducing apparatus 1 in the above described embodiment, the irradiation follow-up controlling unit 7, 11, 46, and 43 is characterized by comprising the irradiation position driving unit (the magnetic circuit 46 and the tangential direction driving coil 43 in this example) that drives an irradiation position in a moving direction (the tangential direction in this example) of the recording medium 2; the driving signal generating unit (the control signal generation circuit 7 and the focal follow-up control circuit 11 in this example) that generates a driving signal (the focal follow-up driving signal in this example) for the irradiation position driving unit 46 and 43 so as to move the irradiation position with following up movement of the recording medium 2 for at least a fixed period based on a result of detecting the irradiation position of the recording/reproduction light beam La by the detecting unit 34; and the recording medium control signal generating unit (the focal follow-up control circuit) 11 that generates a recording medium control signal (the focal follow-up deviation signal) associated with the driving signal generated by the driving signal generating unit 7 and 11, wherein the recording medium controlling unit 4 controls driving of the recording medium driving unit 3 based on the recording medium control signal generated by the recording medium control signal generating unit 11.

When the driving signal generating unit 7 and 11 generate the driving signal based on a result of detecting the irradiation position of the recording/reproduction light Beam La by the detecting unit 34 and the irradiation position driving unit 46 and 43 drive the irradiation position based on this driving signal, the irradiation position follows up movement of the recording medium 2. As a result, irradiation is carried out in a state where a relative irradiation position of the recording/reproduction light beam La on the recording medium 2 is maintained constant for at least a fixed period. At this time, when the recording medium control signal generating unit 11 generates the recording medium control signal in association with the driving signal from the driving signal generating unit 7 and 11 (in order words, in response to the detection result obtained by the detecting unit 34) and the recording medium controlling unit 4 controls driving of the recording medium driving unit 3 based on this recording medium control signal, the follow-up control is compensated. Consequently, the irradiation position of the recording/reproduction light beam La on the recording medium 2 can be stably and assuredly maintained constant.

In the optical information recording/reproducing apparatus 1 in the above described embodiment, the irradiation position driving unit 46 and 43 is characterized by comprising the coil (the tangential direction driving coil in this example) 43 for driving in the moving direction the movable body (the bobbin in this example) 41 including the lens (the object lens in this example) 36 provided in a light path of the recording/reproduction light beam La; and the magnetic circuit (the magnetic circuit in this example) 46 for arranging a magnetic force lines around this coil 43.

The lens 36 provided in the light path of the recording/reproduction light beam La is disposed to the movable body 41 having the coil 43. Further, a driving force is generated in the coil 43 based on an attraction force or a repulsive force that functions between the magnetic force line produced in the coil 43 of the movable body 41 and the magnetic force line arranged by the magnetic circuit 46. As a result, the entire movable body 41 can be driven to drive the irradiation position in the moving direction of the recording medium 2.

In the optical information recording/reproducing apparatus 1 in the above described embodiment, the irradiation position driving unit 46 and 43 drives the irradiation position to reciprocate in a forward direction and an opposite direction of movement of the recording medium, and the driving signal generating unit 7 and 11 are characterized to generate a driving signal including a forward direction component (the focal follow-up driving signal having a positive value in this example) for driving in the forward direction and an opposite direction component (the focal follow-up driving signal having a negative value in this example) for driving in the opposite direction so as to move the irradiation position with following up movement of the recording medium 2 for at least a fixed period.

After starting to irradiate an irradiation target position on the moving recording medium 2, the irradiation position driving unit 46 and 43 drive the irradiation position in the forward direction of movement of the recording medium so as to follow up the moving recording medium 2. As a result, the irradiation position of the recording/reproduction light beam La on the recording medium 2 is maintained constant for at least a fixed period, and highly accurate recording/reproduction (recording or reproduction of information) is executed. Thereafter, in order to irradiate the next irradiation target position on the recording medium 2, the irradiation position driving unit 46 and 43 drive the irradiation position in the opposite direction of movement of the recording medium 2 to be restored to an initial position before follow-up. In the present embodiment, the driving signal generating unit 7 and 11 respectively generate the forward direction component for driving in the forward direction and the opposite direction component for driving in the opposite direction as the driving signal, thereby realizing the above explained reciprocation driving in the forward direction and the opposite direction.

In the optical information recording/reproducing apparatus 1 in the above described embodiment, the recording medium control signal generating unit 11 is characterized by generating a recording medium control signal based on a driving signal in a period the irradiation position is moved with following up movement of the recording medium 2.

When the irradiation position of the recording/reproduction light beam La on the recording medium 2 is stably sufficiently maintained by the follow-up control alone which is effected by the irradiation follow-up controlling unit 7, 11, 46, and 43, a central point of the reciprocating operation of the actual irradiation position based on the driving signal (the follow-up central position in this example) matches with a driving central point of the irradiation position driving unit 46 and 43 (the movable neutral point in this example). That is, the forward direction component and the opposite direction component must have just symmetrical behaviors (behaviors that values match with each other with opposite signs when time integral is carried out). However, when the irradiation position of the recording/reproduction light beam La cannot be necessarily sufficiently maintained constant by the follow-up control alone due to, e.g., driving unevenness of the recording medium driving unit 3, an accuracy limit of driving control, or a restriction of a follow-up control enabled range, the reciprocation center of the actual irradiation position does not match with the driving center of the irradiation position driving unit 46 and 43 (gradually deviating each other).

Further, during this period, by executing the follow-up control with making the irradiation position moved with respect to the following up movement of the recording medium 2, the forward direction component for driving in the forward direction leading to one side region from the driving center of the irradiation position driving unit 46 and 43 and the opposite direction component for driving in the opposite direction leading to the other side region from the driving center do not have the exact symmetrical behaviors (the behaviors that the values match with each other with opposite signs when time integral is carried out), and driving is biased to one of these regions to be increased. In other words, in the driving signal, a component for the biased driven region is increased.

Thus, in the optical information recording/reproducing apparatus 1 in the present embodiment, the recording medium control signal generating unit 11 generates a recoding medium control signal based on a driving signal in a period where movement is effected while following up movement of the recording medium which leads to the reciprocating behavior. As a result, when the recording medium control signal is produced in accordance with the above-described bias of the driving signal component and movement of the recording medium driving unit 3 is controlled by the recording medium controlling unit 4, the follow-up control is compensated. Consequently, the irradiation position of the recording/reproduction light beam La on the recording medium 2 can be stably and assuredly maintained constant.

In the optical information recording/reproducing apparatus 1 in the above described embodiment, the recording medium control signal generating unit 11 is characterized by generating a recording medium control signal associated with a time integral value of a driving signal.

If the driving signal has no bias in a forward direction component or an opposite direction component, providing opposite signs to these components allows the forward direction component and the opposite direction component to offset each other when the entire driving signal is subjected to time integral, and these components must become zero.

Thus, in the optical information recording/reproducing apparatus 1 in the above described embodiment, the recording medium control signal generating unit 11 produces a recording medium control signal in accordance with time integral of the driving signal. As a result, the recording medium control signal is generated assuredly in accordance with the above explained bias of the driving signal component, and the recording medium controlling unit 4 controls driving of the recording medium driving unit 3, thereby effecting follow-up control. As a result, the irradiation position of the recording/reproduction light beam La on the recording medium 2 can be stably and assuredly maintained constant.

In the optical information recording/reproducing apparatus 1 in the above described embodiment, the optical head 5 is characterized by comprising: the recording/reproduction light emitting unit (the recoding/reproduction laser in this example) 21 that emits the recording/reproduction laser beam (the bluish-purple recording/reproduction laser beam) Lao for generating the recording/reproduction light beam La; the servo light emitting unit (the servo laser in this example) 33 that emits the servo laser beam (the red servo laser beam in this example) Lso, which is used to determine an irradiation position of the recording/reproduction laser beam Lao on the recording medium 2, and has a wavelength different from that of the recording/reproduction laser beam Lao; the optical system (the beam splitter 22, the shutter 23, the beam expander 24, the spatial light modulator 25, the first half mirror 26, the first mirror 27, the second mirror 28, the second half mirror 29, the dichroic mirror 31, the third half mirror 32, the movable mirror 35, and the object lens 36 in this example) that irradiates the recording medium 2 with the recording/reproduction light beam La for accessing optical information; and the servo light detector (the servo detector) 34 that detects reflected light of the servo laser beam Lso, which is applied to the recording medium, and reflected with positioning information included therein.

As a result, when recording optical information, the recording/reproduction light emitting unit 21 emits the signal light Ld and the reference light Lr as the recording/reproduction laser beam Lao, and the signal light Ld and the reference light Lr are caused to interfere with each other and applied through the optical systems 22 to 29, 31, 32, 35, and 36, thereby recording the optical information on the recording medium 2. When reproducing optical information, the recording/reproduction light emitting unit 21 emits the reference light Lr as the recording/reproduction laser beam Lao, and the reference light Lr is applied through the optical systems 22 to 29, 31, 32, 35, and 36, thereby reproducing the optical information from the recording medium 2. Further, positional detection at the time of recording or reproduction can be carried out by irradiating the recording medium 2 with the servo laser beam Lso from the servo light emitting unit 33 through the optical systems 22 to 29, 31, 32, 35, and 36 and detecting reflected light of this servo laser beam by using the servo light detector.

The optical information recording/reproducing apparatus 1 in the above described embodiment is characterized in that the recording medium 2 has a discoid shape, and the recording medium driving unit 3 moves the recording medium 2 by driving to rotate the recording medium 2.

In the structure where the recording medium driving unit 3 performs the rotation driving with respect to the discoid recording medium 2, the follow-up control can be compensated when the recording medium controlling unit 4 controls the rotation driving of the recording medium driving unit 3 in cooperation with the follow-up control of the irradiation follow-up controlling unit 7, 11, 46, and 43. As a result, an irradiation position of the recording/reproduction light beam La on the recording medium 2 can be stably and assuredly maintained constant.

On the side note, the present embodiment is not limited in the above explanation and can be modified in many ways. Such variations will be sequentially explained hereinafter.

(1) In case reference voltage for spindle control is generated based on number of rotations of spindle motor

In the above described embodiment, the reference voltage associated with an appropriate number of rotations of the spindle motor is obtained by the dedicated reference voltage generator in the spindle control circuit 4, but the present invention is not restricted thereto. That is, the reference voltage may be obtained based on a number of rotations of the spindle motor 3 at the time so as to perform feedback control of this number of rotations.

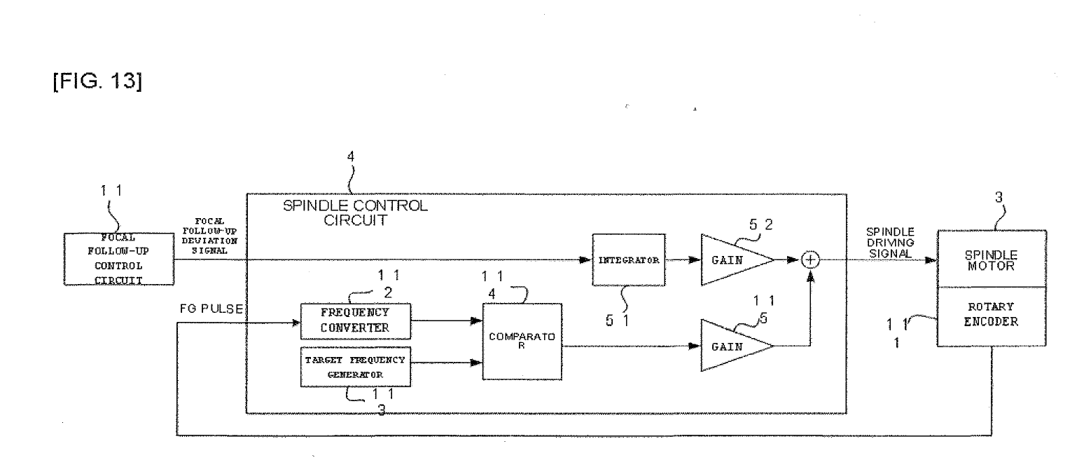

FIG. 13 is a functional block diagram showing a functional structure of a spindle control circuit 104 in this variation, and it is a view associated with FIG. 11 in the above described embodiment. It is to be noted that like reference numerals denote parts equal to the structures of the spindle control circuit 4 in the above described embodiment (see FIG. 1), thereby appropriately omitting an explanation thereof.

In this FIG. 13, in place of the reference voltage generator 53 in FIG. 11, there are provided a rotary encoder 111 that outputs a number of rotations of a spindle motor 3 in the form of an FG pulse signal, a frequency converter 112 that converts the FG pulse signal into a frequency, a target frequency generator 113 that generates a frequency associated with an appropriate number of rotations of the spindle motor, a comparator 114 that compares frequency signals respectively output from the frequency converter 112 and the target frequency generator 113 with each other to output a signal indicative of a comparison result, and a second gain 115 that amplifies the output result signal from the comparator 114.

As a result, the second gain 115 can obtain voltage that functions in the same manner as the reference voltage in the above described embodiment, and the spindle control circuit 104 in this variation can acquire the same effect as that in the above described embodiment. Further, according to this variation, rotation control can be accurately executed as compared with a case where the reference voltage obtained from the independent reference voltage generator 53 is used. Especially, when the spindle control does not adequately function before the focal follow-up operation or in an initial state of the focal follow-up operation, the focal follow-up operation may possibly become unstable. When any other rotation information is fed back before feeding back the focal follow-up deviation signal generated from the focal follow-up control circuit 11 to the spindle control, rotation can be stabilized. Therefore, setting a rotating speed of the optical disk 2 to fall within an appropriate error range before the focal follow-up operation or in the initial state of the focal follow-up operation enables starting the focal follow-up operation in a stabilized state. Moreover, after starting the focal follow-up operation, disturbance of a relatively high frequency is hardly exerted as compared with a case where the reference voltage is utilized.

(2) In case standby period is provided in focal follow-up control

Although a follow-up period is started immediately after a restoration period in the focal follow-up control in the above described embodiment, the present invention is not restricted thereto, and a standby period may be provided between the restoration period and the next follow-up period.

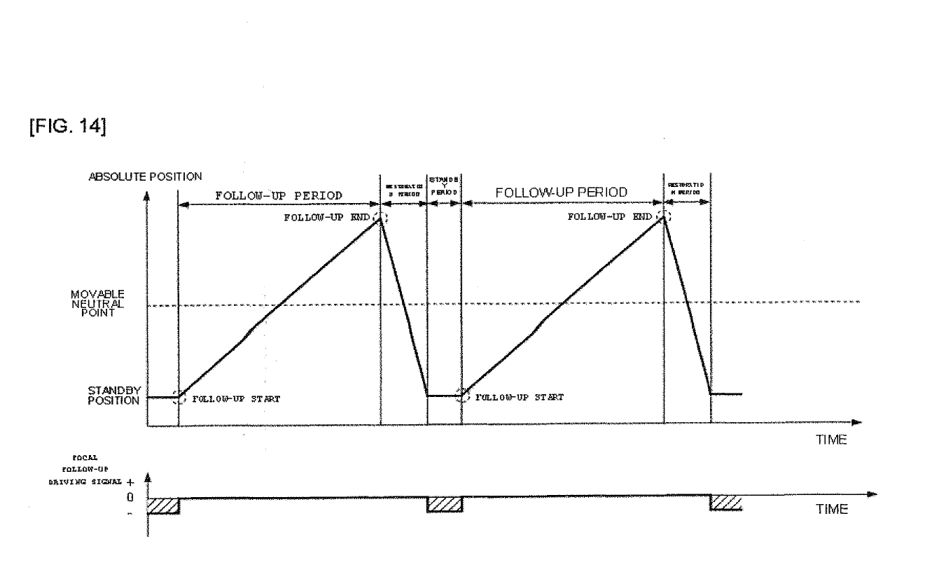

FIG. 14 is a view showing changes in movement position of the object lens 36 and in focal follow-up driving signal with time when a standby period is provided. In this FIG. 14, to provide the focal follow-up operation with a margin, the optical disk 2 is rotated at a relatively low speed, and a standby period where the processing waits until the next data recording/reproducing region arrives while keeping the object lens 36 at a follow-up start position is provided after the restoration period. As a result, even when a rotating speed of the optical disk 2 and a reciprocating operation of the object lens 36 are completely independently controlled without being synchronized with each other, the assured focal follow-up operation can be carried out.

On the side note, even if a follow-up central position is close to a movable neutral point in this case, a focal follow-up driving signal having a negative value is continuously supplied to maintain the object lens 36 on the restoring direction side against resilience of the suspension 45 during the standby period, and a focal follow-up deviation signal associated with this signal is produced. Therefore, the spindle control circuit 104 carries out feedback control to increase a number of rotations of the spindle motor 3, and the standby period is automatically compressed. As a result, a wasteful standby the is omitted, thereby automatically executing an efficient recording/reproducing operation at a high speed.

The hologram recording/reproducing apparatus 1 in the above described embodiment is the hologram recording/reproducing apparatus 1 that irradiates the optical disk 2 adopting the information recording mode utilizing holography with the recording/reproduction light beam La to execute recording/reproduction with respect to the optical disk 2, and it has: the spindle motor 3 that moves the optical disk 2; the pickup 5 that irradiates the optical disk 2 with the recording/reproduction light beam La; the servo detector 34 that detects an irradiation position of the recording/reproduction light beam La emitted from this optical head 5; the control signal generation circuit 7, the focal follow-up control circuit 11, the magnetic circuit 46, and the tangential direction driving coil 43 that execute follow-up control of moving the irradiation position while following up movement of the optical disk 2 for at least a fixed period based on a detection result of this servo detector 34; and the spindle control circuit 4 that controls driving of the spindle motor 3 in cooperation with the follow-up control performed by the control signal generation circuit 7, the focal follow-up control circuit 11, the magnetic circuit 46, and the tangential direction driving coil 43.

In the hologram recording/reproducing apparatus 1 in the present embodiment, the holography type optical disk 2 is driven by the spindle motor 3, and the driven optical disk 2 is irradiated with the recording/reproduction light beam La from the pickup 5, thereby effecting recording/reproduction (recording or reproduction of information) with respect to the optical disk 2. Further, the control signal generation circuit 7, the focal follow-up control circuit 11, the magnetic circuit 46, and the tangential direction driving coil 43 move the irradiation position while following up movement of the optical disk 2 based on a result of detecting the irradiation position of the recording/reproduction light beam La by the servo detector 34, whereby irradiation can be carried out for at least a fixed period in a state where a relative irradiation position of the recording/reproduction light beam La with respect to the optical disk 2 is maintained constant. As a result, recording/reproduction (recording or reproduction of information) can be performed at a relatively high speed with a beam output, which is not very large.

Furthermore, even if there is a possibility that the irradiation position of the recording/reproduction light beam La with respect to the optical disk 2 cannot be necessarily sufficiently maintained constant by the follow-up control alone which is performed by the control signal generation circuit 7, the focal follow-up control circuit 11, the magnetic circuit 46, and the tangential direction driving coil 43 due to, e.g., driving (including rotation) unevenness of the spindle motor 3, an accuracy limit of driving control, or a restriction in a follow-up control enabled range, the follow-up control can be compensated when the spindle control circuit 4 controls driving of the spindle motor 3 in association with the follow-up control performed by the control signal generation circuit 7, the focal follow-up control circuit 11, the magnetic circuit 46, and the tangential direction driving coil 43. As a result, the irradiation position of the recording/reproduction light beam La with respect to the optical disk 2 can be stably and assuredly maintained constant.

The hologram recording/reproducing apparatus 1 in the above described embodiment is the hologram recording/reproducing apparatus 1 that irradiates the optical disk 2 adopting the information recording mode utilizing holography with the reference light Lr to perform reproduction with respect to the optical disk 2, and it has: the spindle motor 3 that moves the optical disk 2; the pickup 5 that irradiates the optical disk 2 with the reference light Lr; the servo detector 34 that detects an irradiation position of the reference light Lr emitted from this optical head 5; the control signal generation circuit 7, the focal follow-up control circuit 11, the magnetic circuit 46, and the tangential direction driving coil 43 that execute follow-up control of moving the irradiation position while following up movement of the optical disk 2 for at least a fixed period based on a detection result of this servo detector 34; and the spindle control circuit 4 that controls driving of the spindle motor 3 in cooperation with the follow-up control performed by the control signal generation circuit 7, the focal follow-up control circuit 11, the magnetic circuit 46, and the tangential direction driving coil 43.

In the hologram recording/reproducing apparatus 1 in the present embodiment, the holography type optical disk 2 is driven by the spindle motor 3, and the driven optical disk 2 is irradiated with the reference light Lr from the pickup 5, thereby reproducing information from the optical disk 2. Moreover, the control signal generation circuit 7, the focal follow-up control circuit 11, the magnetic circuit 46, and the tangential direction driving coil 43 move the irradiation position while following up movement of the optical disk 2 based on a result of detecting the irradiation position of the reference light Lr by the servo detector 34. As a result, irradiation can be performed for at least a fixed period in a state where a relative irradiation position of the reference light Lr with respect to the optical disk 2 is maintained constant. Consequently, information can be reproduced at a relatively high speed with a beam output, which is not very large.

Further, even if there may be possibility that the irradiation position of the reference light Lr with respect to the optical disk 2 cannot be necessarily sufficiently maintained constant by the follow-up control alone which is performed by the control signal generation circuit 7, the focal follow-up control circuit 11, the magnetic circuit 46, and the tangential direction driving coil 43 due to, e.g., driving (including rotation) unevenness of the spindle motor 3, an accuracy limit of driving control, or a restriction in a follow-up control enabled range, the follow-up control can be compensated when the spindle control circuit 4 controls driving of the spindle motor 3 in cooperation with the follow-up control performed by the control signal generation circuit 7, the focal follow-up control circuit 11, the magnetic circuit 46, and the tangential direction driving coil 43. As a result, the irradiation position of the reference light Lr with respect to the optical disk 2 can be stably and assuredly maintained constant.

Further, the optical information recording/reproducing method carried out by the hologram recording/reproducing apparatus 1 according to the above described embodiment is the optical information recording/reproducing method of moving the optical disk 2 adopting the information recording mode utilizing holography and irradiating the moving optical disk 2 with the recording/reproduction light beam La to perform recording/reproduction with respect to the optical disk 2, and this method is characterized by detecting an irradiation position of the recording/reproduction light beam La, causing the irradiation position to follow up movement of the optical disk 2 for at least a fixed period based on a detection result of this irradiation position, and controlling driving the optical disk 2 in cooperation with this follow-up.

In the optical information recording/reproducing method carried out by the hologram recording/reproducing apparatus 1 in the present embodiment, the holography type optical disk 2 is moved, and the moving optical disk 2 is irradiated with the recording/reproduction light beam La to perform recording/reproduction (recording or reproduction of information) with respect to the optical disk 2. Furthermore, the irradiation position is caused to follow up movement of the optical disk 2 based on a result of detecting the irradiation position of the recording/reproduction light beam La, whereby irradiation can be executed for at least a fixed period in a state where a relative irradiation position of the recording/reproduction light beam La with respect to the optical disk 2 is maintained constant. As a result, recording/reproduction (recording or reproduction of information) can be performed at a relatively high speed with a beam output, which is not very large.

Moreover, even if there is a possibility that the irradiation position of the recording/reproduction light beam La with respect to the optical disk 2 cannot be necessarily sufficiently maintained constant by the follow-up control alone due to, e.g., driving unevenness of the optical disk 2, an accuracy limit of driving control, or a restriction in a follow-up control enabled range, controlling driving the optical disk 2 in cooperation with the follow-up enables compensating the follow-up control. As a result, the irradiation position of the recording/reproduction light beam with respect to the optical disk 2 can be stably and assuredly maintained constant.

1. An optical information recording/reproducing apparatus that performs recording/reproduction on a recording medium by irradiating said recording medium adopting an information recording mode utilizing holography with a recording/reproduction light beam, comprising:
a recording medium driving unit that moves said recording medium;
an optical head for irradiating said recording medium with said recording/reproduction light beam;
a detecting unit that detects an irradiation position of said recording/reproduction light beam emitted from said optical head;
an irradiation follow-up controlling unit that executes follow-up control for moving said irradiation position with following up movement of said recording medium for at least a fixed period based on a detection result of said detecting unit; and
a recording medium controlling unit that controls driving of said recording medium driving unit in cooperation with said follow-up control performed by said irradiation follow-up controlling unit.

2. The optical information recording/reproducing apparatus according to claim 1, wherein
said irradiation follow-up controlling unit comprises:
an irradiation position driving unit drives said irradiation position in a moving direction of said recording medium;
a driving signal generating unit generates a driving signal for said irradiation position driving unit so as to move said irradiation position while following up movement of said recording medium for at leas: a fixed period based on a result of detecting said irradiation position of said recording/reproduction light beam by said detecting unit; and
a recording medium control signal generating unit generates a recording medium control signal associated with said driving signal generated by said driving signal generating unit, and
said recording medium controlling unit controls driving of said recording medium driving unit based on said recording medium control signal generated by said recording medium control signal generating unit.

3. The optical information recording/reproducing apparatus according to claim 2, wherein
said irradiation position driving unit comprises:
a coil which is used to drive a movable body including a lens provided in a light path of said recording/reproduction light beam in said moving direction; and
a magnetic circuit, which is used to arrange a magnetic force line around said coil.

4. The optical information recording/reproducing apparatus according to claim 2, wherein
said irradiation position driving unit drives said irradiation position to reciprocate in a forward direction and an opposite direction with respect to movement of said recording medium, and
said driving signal generating unit generates said driving signal including a forward direction component for driving in said forward direction and an opposite direction component for driving in said opposite direction so as to move said irradiation position while following up movement of said recording medium for at least a fixed period.

5. The optical information recording/reproducing apparatus according to claim 4, wherein
said recording medium control signal generating unit generates said recording medium control signal based on said driving signal in a period where said irradiation position is moved while following up movement of said recording medium.

6. The optical information recording/reproducing apparatus according to claim 4, wherein
said recording medium control signal generating unit generates said recording medium control signal associated with a time integral value of said driving signal.

7. The optical information recording/reproducing apparatus according to claim 1, wherein
said optical head comprises:
a recording/reproduction light emitting unit that emits a recording/reproduction laser beam for generating said recording/reproduction light beam;
a servo light emitting unit that emits a servo laser beam, which is used to determine an irradiation position of said recording/reproduction light beam with respect to said recording medium, and has a wavelength different from that of said recording/reproduction laser beam;
an optical system that irradiates said recording medium with said recording/reproduction light beam and said servo laser beam for accessing optical information; and
a servo light detector that detects reflected light of said servo laser beam, which is applied to said recording medium, and reflected with positioning information included therein.

8. The optical information recording/reproducing apparatus according to claim 1, wherein
said recording medium has a discoid shape, and
said recording medium driving unit moves said recording medium by driving said recording medium to rotate.

9. An optical information reproducing apparatus that performs reproduction on a recording medium by irradiating said recording medium adopting an information recording mode utilizing holography with a reproduction light beam, comprising:
a recording medium driving unit that moves said recording medium;
an optical head that irradiates said recording medium with said reproduction light beam;
a detecting unit detects an irradiation position of said reproduction light beam emitted from said optical head;
an irradiation follow-up controlling unit that executes follow-up control to move said irradiation position with following up movement of said recording medium for at least a fixed period based on a detection result of said detecting unit; and
a recording medium controlling unit that controls driving of said recording medium driving unit in cooperation with said follow-up control performed by said irradiation follow-up controlling unit.

10. An optical information recording/reproducing method for performing recording/reproduction on said recording medium by moving said recording medium adopting an information recording mode utilizing holography and irradiating said moving recording medium with a recording/reproduction light beam, comprising:
a step for detecting an irradiation position of said recording/reproduction light beam; and
step for causing said irradiation position to follow up movement of said recording medium for at least a fixed period based on a detection result of said irradiation position, and controlling driving of said recording medium in cooperation with said follow-up.
